(19) United States
(12) Patent Application Publication
(10) Pub. No.: US 2026/0316809 A1
(43) Pub. Date: Oct. 15, 2026

(54) COMPACT LOADING EQUIPMENT

(71) Applicant: Rehrig Pacific Company, Monterey Park, CA (US)

(72) Inventors: Dane Gin Mun Kalinowski, Foothill Ranch, CA (US); Joseph E. Popovits, II, Costa Mesa, CA (US)

(21) Appl. No.: 19/648,791

(22) Filed: Apr. 15, 2026

Related U.S. Application Data
(60) Provisional application No. 63/789,284, filed on Apr. 15, 2025.

(51) Int. Cl. B62B 3/06; B62B 3/02; B62B 5/00

(52) U.S. Cl. CPC B62B 3/0612; B62B 3/02; B62B 5/004

(57) ABSTRACT

A compact pallet mover includes a pallet interface supported above a floor by a plurality of wheels. Each wheel is connected to the pallet interface by a wheel interface configured to independently raise/lower the pallet interface and pivot the wheel about a vertical axis, enabling four-wheel steering, tilting, and improved traction. In another configuration, the pallet mover includes a split base with fork tines and a base wheel positioned directly beneath the base via a gear train connected to an external tiller arm. Additional features include adjustable tines, pallet retention elements on the tines, integrated sensors, and controller functions for stability and differential steering.

### BACKGROUND

Conventional pallet movers and pallet jacks often suffer from limited maneuverability in tight spaces, such as retail store aisles. Powered versions frequently provide insufficient traction under load, and many designs are excessively long, making them difficult to operate efficiently in confined areas.

### SUMMARY

In some aspects, the techniques described herein relate to a pallet mover including: a pallet interface configured to support a load; a plurality of wheels supporting the pallet interface above a floor; and a plurality of wheel interfaces, each wheel interface connecting an associated one of the plurality of wheels to the pallet interface, wherein each wheel interface is configured to selectively increase and decrease a distance between the associated wheel and the pallet interface and to pivot the associated wheel about a vertical axis independently of others of the plurality of wheel interfaces.

In some aspects, the techniques described herein relate to a pallet mover wherein each of the plurality of wheels is powered.

In some aspects, the techniques described herein relate to a pallet mover wherein each of the plurality of wheels includes a hub motor.

In some aspects, the techniques described herein relate to a pallet mover further including a controller configured to independently control each wheel interface so as to selectively raise, lower, tilt, and steer the pallet interface.

In some aspects, the techniques described herein relate to a pallet mover further including a battery mounted to an underside of the pallet interface.

In some aspects, the techniques described herein relate to a pallet mover wherein all of the plurality of wheels are positioned directly below the pallet interface.

In some aspects, the techniques described herein relate to a pallet mover wherein the wheel interfaces are configured to tilt the pallet interface about both a longitudinal axis and a lateral axis.

In some aspects, the techniques described herein relate to a pallet mover wherein the pallet interface is one of a blade or a set of fork tines.

In some aspects, the techniques described herein relate to a pallet mover further including a mast extending upwardly from the pallet interface, the mast including handlebars at an upper end thereof and a user interface mounted below the handlebars.

In some aspects, the techniques described herein relate to a pallet mover further including a controller including at least one of a traction control feature, a stability control feature that limits speed based on lift height or steering angle, and a differential steering feature.

In some aspects, the techniques described herein relate to a pallet mover including: a base split into right and left halves; a pair of fork tines extending forward from the base; a base wheel supporting the base; and a tiller arm having a vertical portion positioned between the right and left halves of the base, the tiller arm operatively connected to the base wheel such that rotation of the tiller arm rotates the base wheel about a vertical axis, wherein the positioning of the vertical portion between the halves places the base wheel closer to the fork tines than in a conventional pallet jack configuration.

In some aspects, the techniques described herein relate to a pallet mover further including a pair of load wheels, one supporting each fork tine, and wherein the base further includes a lift actuator configured to selectively raise and lower the base and the fork tines relative to the base wheel and the load wheels.

In some aspects, the techniques described herein relate to a pallet mover further including tine spacing actuators mounted in the base and configured to selectively move the fork tines laterally toward and away from one another.

In some aspects, the techniques described herein relate to a pallet mover further including a steering angle sensor configured to detect a rotational position of the base wheel relative to the base.

In some aspects, the techniques described herein relate to a pallet mover further including at least one of a lift height position sensor and a fork width position sensor.

In some aspects, the techniques described herein relate to a pallet mover further including a pallet position sensor mounted to an underside of at least one of the fork tines proximate a forward end thereof.

In some aspects, the techniques described herein relate to a pallet mover wherein the fork tines each include an upper support surface having a plurality of elastomeric inserts protruding upwardly therefrom, the inserts positioned so as to be received between ribs of a pallet deck when the pallet is supported on the fork tines.

In some aspects, the techniques described herein relate to a pallet mover wherein each fork tine includes an upper support surface having a plurality of raised projections separated by a grid of grooves, the raised projections and grooves configured to interlock with ribs of a pallet deck supported on the fork tines.

In some aspects, the techniques described herein relate to a pallet mover further including a gear train operatively connecting the tiller arm to the base wheel such that the tiller arm remains outside the base while the base wheel is positioned directly beneath the base.

In some aspects, the techniques described herein relate to a pallet mover including: a base; a pair of tines extending forward from the base, the tines configured to support a pallet; a base wheel supporting the base, wherein the base wheel is positioned directly below the base; a tiller arm for steering the pallet mover; a first gear rotatable by the tiller arm about a vertical axis; a steering gear driven by the first gear and fixed to a vertical shaft connected to the base wheel, such that rotation of the tiller arm causes the base wheel to pivot about a vertical axis.

In some aspects, the techniques described herein relate to a pallet mover wherein the base is split into right and left halves, and wherein the vertical axis about which the base wheel pivots is located between the two halves of the base.

In some aspects, the techniques described herein relate to a pallet mover wherein the right and left halves of the base each contain at least one of: electronics and wiring, one or more batteries, a hydraulic fluid reservoir, or ballast weight.

### BRIEF DESCRIPTION OF THE DRAWINGS

FIG. 1 is a perspective view of a pallet mover according to a first embodiment.

FIG. 2 is a perspective view of the underside of the pallet interface of FIG. 1.

FIG. 3 is a perspective view of the pallet mover supporting two half pallets, each having a plurality of items thereon.

FIG. 4 is a bottom view of the pallet mover of FIG. 1.

FIG. 5 is a front perspective view of the pallet mover of FIG. 1.

FIG. 6 is a front perspective view of a pallet mover according to a second embodiment.

FIG. 7 is a bottom perspective view of the pallet mover of FIG. 6.

FIG. 8 is a perspective view of the pallet mover of FIG. 6.

FIG. 9 shows a half pallet on the pallet mover positioned against the backrest of the pallet interface.

FIG. 10 shows the pallet mover of FIG. 6 in use with a modified pallet mover.

FIG. 11 is a perspective view of a pallet mover according to another embodiment.

FIG. 12 is a perspective view of the pallet mover of FIG. 11 with the tines in a retracted position.

FIG. 13 is a perspective view of the pallet mover of FIG. 11 with the tines in an expanded position.

FIG. 14 is a side view of the pallet mover of FIG. 11 with the tines and base in a low position.

FIG. 15 is a side view of the pallet mover of FIG. 11 with the tines and base in a raised position.

FIG. 16 is a side view of the pallet mover of FIG. 11 in a fully raised position.

FIG. 17 is a side view of a lower portion of the pallet mover of FIG. 11 adjacent the corresponding structure of a prior art pallet mover.

FIG. 18 is a perspective view of a base wheel area of a pallet mover according to another embodiment.

FIG. 19 is a front view of the pallet mover of FIG. 18.

FIG. 20 is a rear view of the upper backrest area of the pallet mover of FIG. 18.

FIG. 21 is a bottom view of the ends of the tines of the pallet mover of FIG. 18.

FIG. 22 is a perspective view of a pallet mover according to another embodiment.

FIG. 23 is a top view of the tines of the pallet mover of FIG. 22.

FIG. 24 is a perspective view of one of the tines of the pallet mover of FIG. 22, with a pallet supported thereon, with both the pallet and the tine partially broken away.

FIG. 25 is a side view of the tine and pallet of FIG. 24.

FIG. 26 is a perspective view of a pallet mover according to another embodiment.

FIG. 27 is a top view of the pallet mover of FIG. 26.

FIG. 28 is a perspective view of the pallet mover of FIG. 26 with a pallet supported on the tines, the pallet being partially broken away.

FIG. 29 is an enlarged view of a portion of FIG. 28.

FIG. 30 is a perspective view of a pallet mover according to another embodiment.

FIG. 31 is an enlarged view of the base wheel area of the pallet mover of FIG. 30.

FIG. 32 is a side view of the pallet mover of FIG. 30.

FIG. 33 shows the base wheel area of FIG. 30 with an alternate connection to the steering gear.

### DETAILED DESCRIPTION

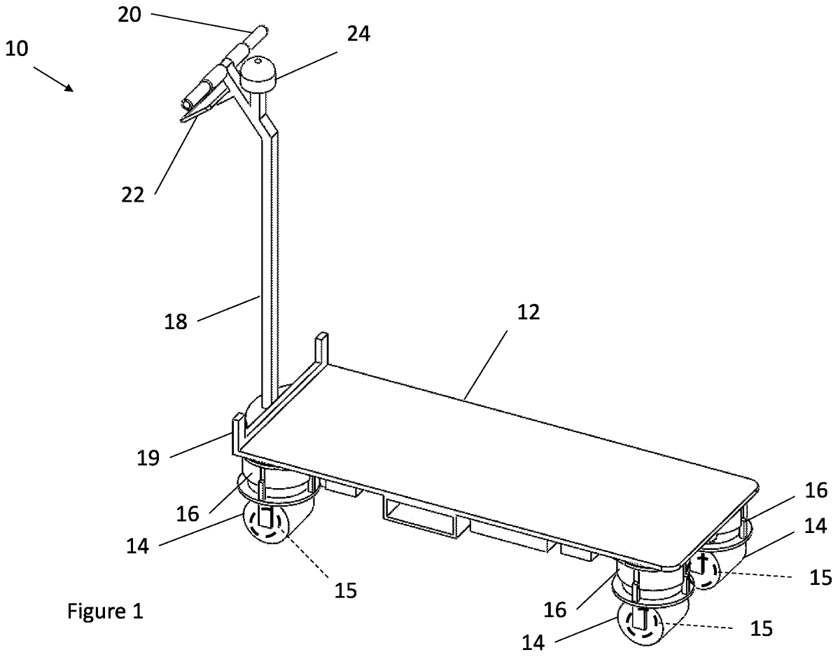

A pallet mover 10 according to a first embodiment is shown in FIG. 1. The pallet mover 10 includes a pallet interface 12, such as a blade as shown, but could also be fork tines, pads, etc. The pallet interface 12 is supported above a floor by a plurality of wheels 14. In this example, there are four wheels 14. Each wheel 14 is powered to drive the pallet mover 10 forward or reverse, such as by including a hub motor 15 therein or otherwise driven by a motor. Alternatively, only two of the wheels 14 are powered and two are free rolling.

A wheel interface 16 between each wheel 14 and the pallet interface 12 is configured to selectively increase and decrease the distance between the wheel 14 and the pallet interface 12. The wheel interface 16 is also configured to pivot each wheel 14 about a vertical axis (e.g. perpendicular to the floor and to the pallet interface 12). The pivoting and lifting functions can be performed independently for each wheel 14, such that the entire pallet interface 12 can be raised and lowered relative to the floor and can be tilted front to back or side to side. The ability to pivot each wheel 14 about a vertical axis independently provides four-wheel steering and lateral movement.

Alternatively, the pallet mover 10 could lift the load off the ground through a variety of mechanisms, actuated in a variety of ways, other than the wheel interface 16. The power source could be pneumatic, hydraulic, electric such as a linear actuator or geared electric motor, or human powered via foot actuation or hand actuation.

Pallet interface 12 could be fork tines, a pallet or load cradle, a flat blade or tray, a horizontal clamp mechanism (floor loads), powered or non-powered rollers, bosses or recesses which engage features on the pallet or load, latch(es) which lock into feature(s) on the load or pallet, or a combination of any of the above. The pallet interface 12 could be changeable depending on the load and use case.

The power source could be used to directly lift the load or power other lifting mechanisms. The wheel interfaces 16 could create purely vertical movement, purely tilting movement, or a combination of the two.

The lifting movement could also be combined with horizontal load movement. The horizontal load movement could be fore and aft, or it could be side to side, or a combination of both. It could be done automatically or controlled by the operator. Horizontal movement could be used to improve load stability and equipment traction by shifting the load closer to the driven wheel(s), even completely over the top of the driven wheel(s).

The pallet mover 10 further includes a mast 18 having handlebars 20 at an upper end thereof. The mast 18 extends vertically from the pallet interface 12 forward of a backrest 19. A user interface 22 is mounted to the mast 18 just below the handlebars 20. The user interface 22 may be a portable electronic device such as a smartphone or tablet. A plurality of sensors 24 may be mounted to the mast 18. The sensors 24 may include noncontact distance sensors, like optical light based type of sensor, such a camera or a distance camera. Based upon images from the plurality of sensors 24, the controller can determine if there is a pallet on the pallet interface 12, how many pallets are on the pallet interface 12, and how tall the pallet and goods stacked thereon are. This information would be used by the controller to assist in stability control (e.g. reduced speed, acceleration, turning and braking for a taller stack of goods). The controller can also identify (or simply image) the operator of the pallet mover 10 for logging that information. The controller can analyze the surroundings of the pallet mover 10, such as obstacles for autonomous or semi-autonomous operating. The controller may log continuous video for documentation of accidents. All this information may be transmitted to a remote server for logging and analysis of the information from a fleet of such pallet movers 10.

Operation controls (not shown) would also be attached to the mast 18 and/or handlebars 20, such as twist throttle(s), joystick(s), thumb throttle(s), button(s), or any other user controllers. Steering control can be of any type including “headless” (without mast 18 and handlebars 20 but controlled remotely), or autonomously, or as a following train.

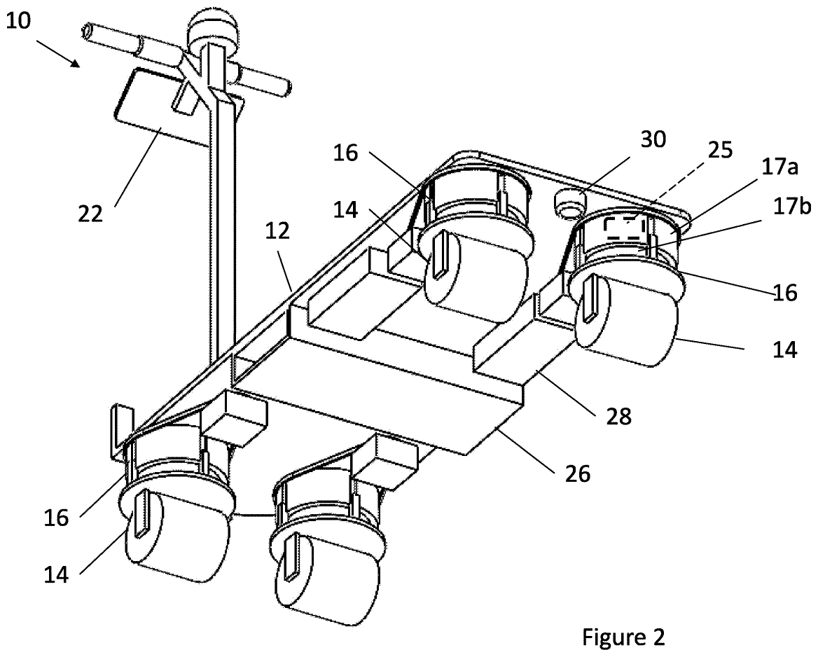

FIG. 2 is a perspective view of the underside of the pallet interface 12. Each of the wheel interfaces 16 lifts the pallet interface 12, which in this example means it increases the distance between the associated wheel 14 and the pallet interface 12. In this example, each wheel interface 16 includes two or more telescoping housings, such as an upper housing 17a and a lower housing 17b that is slidably received in the upper housing 17a. A lift actuator 25 inside the upper housing 17a and/or the lower housing 17b moves the lower housing 17b toward and away from the upper housing 17a to increase the distance between the associated wheel 14 and the pallet interface 12. The lift actuator 25 could be a geared electric motor, screw drive, hydraulic cylinder, linear actuator, pneumatic actuator or any suitable device.

In FIG. 2, this is only shown for one wheel interface 16, but the rest are identical. Again, each wheel interface 16 can increase or decrease the distance between its associated wheel 14 and the pallet interface 12 to provide lift and tilt about both the longitudinal and lateral axes of the pallet interface 12.

A battery 26 is mounted to the underside of the pallet interface 12. The battery 26 could be integrated or hot-swappable. In order to keep the pallet mover 10 as compact as possible with a low center of gravity, the battery 26 could be integrated into the chassis. The battery 26 could be a single unit, or it could be split into multiple sections. The battery(s) 26 could be permanently fixed to the unit, or they could be quickly replaceable. The pallet mover 10 may not need all the battery positions installed that are available on the lift to function.

The pallet mover 10 may be designed to accept a certain battery chemistry which improves the performance of the lift, for example using lightweight LiFePO4 chemistry in the handle, or using Lead Acid down underneath the lifting structure.

A controller 28 is also mounted to the underside of the pallet interface 12 and could have a specialized profile to fit in a special area of the chassis. Additional sensors 30 may be mounted to the pallet interface 12 for spatial awareness, stability aids, driving aids, autonomous driving, etc. The pallet mover 10 could have features or devices built into it which allow future autonomous features or operation to be activated or used. The autonomous functionality could be operator feedback, such as distance sensing used to alert operator of nearby objects, or full autonomous operation, or any range in between.

The controller 28 includes at least one processor and at least one storage which stores computer programs which when executed by the at least one processor causes the pallet mover 10 to perform the functions described herein. The wheel 14, user interface 22, wheel interfaces 16, and plurality of sensors 24, 30 are connected to the controller 28.

The drive controller, lift/lower controller, steering controller, and stability controller could all be one unit (e.g. controller 28), or separate units, or a combination of any of them. The pallet mover 10 could use a specially sized controller 28 to fit into a location which allows the pallet mover 10 to maintain its low center of gravity and high traction capability. The controller 28 could be specially designed controller to control one or more motors from a single controller unit.

The drive controller could have automatic features which turn on as needed, or there could be features which are user-activated. The features could be binary on and off, or they could be adjustable from off to fully on.

Drive controller examples of these features could be traction control, max speed limiting, coast or regeneration levels.

Lift lower controller could be one touch or automatic load lifting or lowering, load tilting.

Steering controller could be steering ratio, tip-preventing intervention, steering mode (crab, rotate, front steer, rear steer, combinations).

Stability controller adjusts the max speed based on sensor inputs and/or adjusts the load tilting based on sensor inputs.

The drive, steering, and any other controllers within the pallet mover 10 could be networked together to share sensor inputs and lift state information such that the controllers are working collaboratively to adjust the equipment performance.

The controller architecture supports a single unit controller 28, separate domain-specific units, or any combination. Rather than fixing the controller topology at design time, the architecture allows drive, lift/lower, steering, and stability functions to be distributed or consolidated based on the configuration, with all controllers sharing sensor inputs and equipment state in real time. This creates a unified state machine where every domain has full situational awareness: the drive controller knows the steering angle and lift height, the stability controller knows the load weight from hydraulic line pressure, and the steering controller knows when a lift event is in progress.

Cross-domain collaboration means the system can catch and respond to safety conditions earlier than any single-domain controller—stability can preempt a tip risk by commanding the drive controller before the condition develops, not after. Mode selection across the full spectrum—crab steer, rotate, front/rear steer, and combinations—is managed by this shared state without hardware changes, allowing the same machine to operate in fundamentally different configurations through a control profile change. One-touch and automatic lifting are coordinated with the mechanical tilt-height relationship built into the linkage geometry, meaning the controller accounts for a physical coupling that doesn't exist in conventional machines.

Adding a new sensor propagates its data to all domains immediately through the shared state architecture, making the platform extensible without rewiring. The controller 28 provides unified real-time state machine that governs all domains simultaneously on a compact under-load platform.

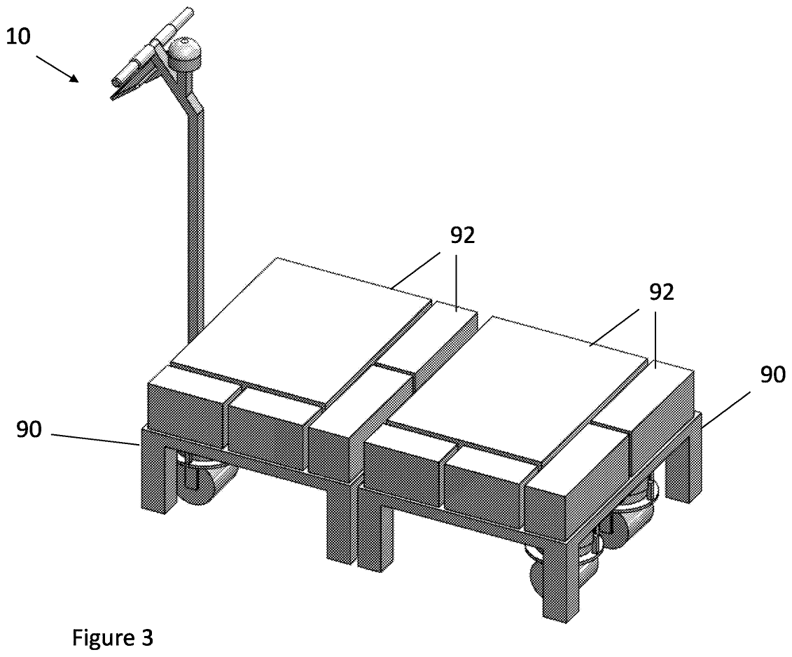

FIG. 3 is a perspective view of the pallet mover 10 supporting two half pallets 90, each having a plurality of items 92 thereon. Alternatively, items 92 could be supported directly on the pallet interface 12.

The pallets 90 could have features which engage or are engaged by the pallet interface 12 which improve the load stability. Integrated into pallet, interlocking between platform/pallet, multiple pallet sizes or none required at all, direct product onto blade.

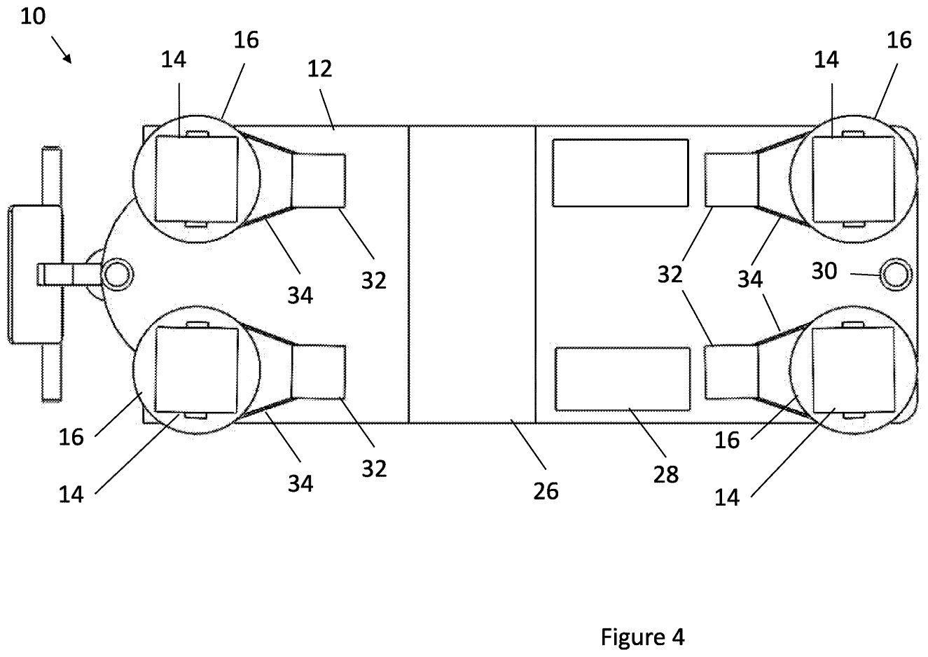

FIG. 4 is a bottom view of the pallet mover 10. As shown, the mechanism for turning each wheel 14 about its vertical axis could include a motor 32 driving a belt 34 to rotate the wheel interface 16 and wheel 14 relative to the pallet interface 12. Alternatively, the motor 32 could drive a chain, pulleys, gears, linkage or the motor 32 could be configured as a servo motor. Alternatively, the wheels 14 could be pivoted mechanically by manual user input, or some combination of these methods.

Each wheel 14 is independently rotatable about its vertical axis, which enables many options for maneuvering the pallet mover 10, such as lateral movement (side to side), diagonally, spinning about a vertical axis, making any radius turn, and any combination of these maneuvers.

Because all the wheels 14 are directly below the pallet interface 12, traction for the wheels is maximized. The pallet mover 10 uses one or more small diameter powered wheels 14 positioned much closer to the load, or partially or even fully underneath it, such that the driven wheels 14 are under much higher loading force compared with most standard electric pallet jacks. The increased loading force improves the driven wheel 14 traction and reduces the probability of wheel slip. This can prevent major delays and the extra effort associated with traction issues of standard electric pallet jacks.

The method of driving could be small driven wheels 14, a series of small driven wheels 14, a driven wheel 14 which drives one or more non-driven wheels, or a combination of them. The equipment could have one or more main driven wheels 14 with additional supportive wheels that may not be touching the ground all the time, and the supportive wheels could be powered or not. The driven wheels 14 could also be an omni style wheel, with the main wheel powered and outer radial wheels powered.

The pallet mover 10 could have compact driven wheel(s) 14 that are specially sized and designed to fit underneath the pallet interface 12, in order to produce the needed high torque and drive force. The driven wheels 14 could each be a directly powered self-contained unit (such as with a hub motor within the wheel 14), or it could be a combination of components spread out, that transmit power indirectly to the compact driven wheel 14. An indirect drive system would not require the drive motor and drive wheel 14 to be axially aligned and therefore permit more flexible placement of the motor and a larger and more powerful motor could be used. Separating the motor from the driven wheel 14 would also allow more flexibility for the driven wheel 14 to placement, ultimately increasing the traction and stability of the equipment.

The power from the motor could be transmitted to a drive system. The drive system could be a track system, and there could be multiple powered motors powering one track system, or one motor powering one or more track systems.

In order to keep the small diameter drive wheels but increase the total equipment driving power, multiple wheels configured in a row or side by side could be used. The drive wheels could have hub motors therein.

The tread could be permanently bonded to the wheel, replaceable, or a track style. The tread could be tailored to the application or load. The tread could be adjustable as well, such as a pneumatic outer casing that could be aired up or down to adjust the diameter, adjust the compliance, or adjust the traction.

The tread on the wheel 14 could be replaceable or integrated into the driven hub. The tread could have wear indicating features, and the indication could be visual such as a red stripe that becomes visible once worn, a debossed shape, which disappears as the tread is worn. The indication could be audible, such as a different material which makes noise when the wear allows it to contact the ground. The indication could be physical, such as a section of the tread that wears differently and allows the operator to feel that the tread has worn. The treadwear could also be measured by the equipment controller.

The pallet mover 10 could have stabilizing features that increase the stability of the lift and or load. The features could be moveable vertically, horizontally, or both. The stabilizing features could be controlled electronically separately from the other equipment operation, or automatically working together with other aspects of the equipment to stabilize the load.

### Steering Speed Sensitive, AWD Differential Steering

The pallet mover 10 optionally includes a system which reduces the speed of the equipment based on the equipment and or load state. The pallet mover 10 could also use what we coined differential steering to improve the turning radius and reduce wheel scrub for an AWD lift. This differential steering would be very advantageous during a 0-radius turn, where certain wheel may need to spin in opposite directions in order to minimize wheel scrub and maximize maneuverability.

### Active Anti Tip, Steering Sensitive Throttle

The pallet mover 10 optionally includes features which control the stability of the load, lift, or both. The method to reduce the risk of tipping includes software features, such as speed reduction based on equipment state, e.g. steering angle, lift speed, lift height, etc. to prevent the load from tipping over.

The stability control optionally be a combination of hardware and software features, such as the lowering of a load at higher speeds to reduce the center of gravity and risk of tipping, or adjusting the stability casters on the pallet mover 10 to decrease the weight transfer and change the CG during a turn.

The pallet mover 10 could use any number of driven wheels and idle wheels, and the chassis could have features allowing for modular installation or replacement of one style wheel for another, for example replacing a single set of wheels with a tandem set of wheels.

The driven wheels could be all the same size and design, or they could be a combination of different types of wheels and motors. For example, the main drive motor could be a low gear reduction hub motor which is used in all scenarios and capable of driving the equipment at a wide range of speed, but the front two wheels could be very high gear reduction hub motors which are used only for low speed acceleration,

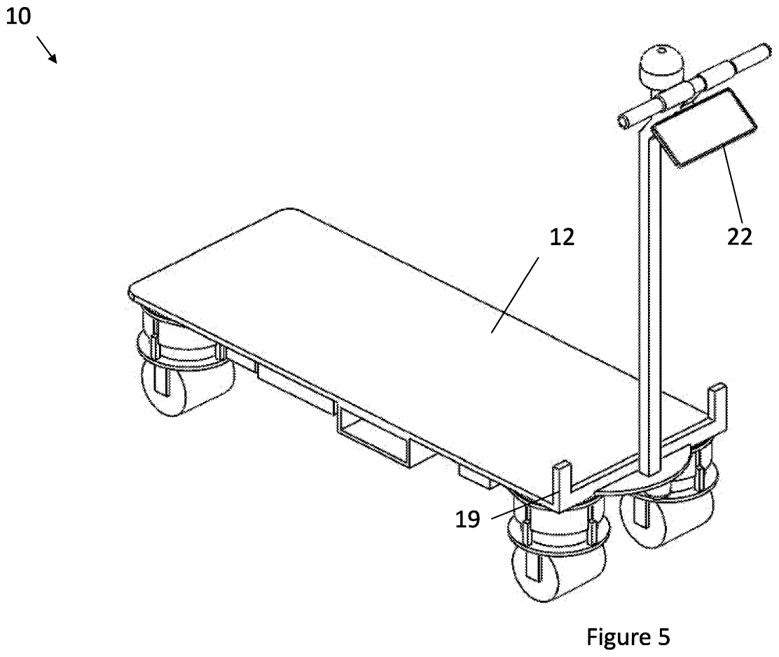

FIG. 5 is a front perspective view of the pallet mover 10.

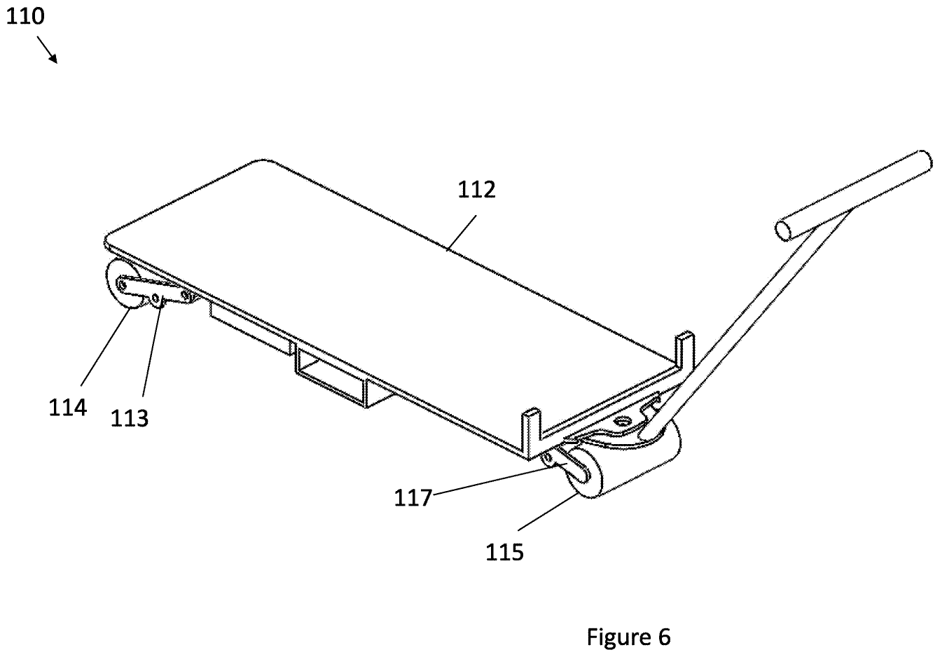

FIG. 6 is a front perspective view of a pallet mover 110 according to a second embodiment. The pallet mover 110 may include any combination of features described above with respect to the first embodiment of the pallet mover 10. The pallet mover 110 includes two rear wheels 114, which again may be driven to power the pallet mover 110 such as by hub motors therein. A pair of arms 113 pivot the rear wheels 114 relative to the pallet interface 112 similar to a standard pallet jack.

In this embodiment, there is a single front wheel 115 connected by pivoting arms 117 raise and lower the pallet interface 112. The single front wheel 115 may be significantly wider than the two rear wheels 114, e.g. having a width greater than the total width of the two rear wheels 114. The single front wheel 115 may also be powered to drive the pallet mover 110, such as by a hub motor. If the single front wheel 115 is not completely under the pallet interface 112, it may be partially under the pallet interface 112 to improve traction.

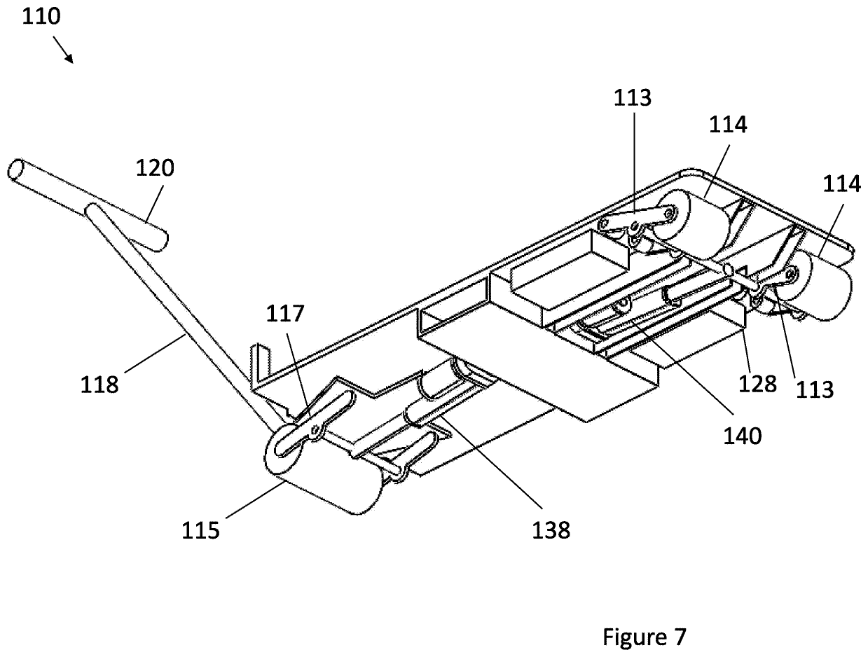

FIG. 7 is a bottom perspective view of the pallet mover 110 of FIG. 6. The single front wheel 115 may be pivoted relative to the pallet interface 112 by a first hydraulic piston 138. The two rear wheels 114 may also be pivoted relative to the pallet interface 112 by a second hydraulic piston 140. The first hydraulic piston 138 and second hydraulic piston 140 are controlled by the controller 128, which may be substantially similar to the controller 28 of the first embodiment.

Any of the wheels 114, 115 could be steerable electrically, with cables, gears, linkage, manually or a combination. In this embodiment the single front wheel 115 is liftable electrically separately from the two rear wheels 114 and the single front wheel 115 is steerable manually via the mast 118.

The style of lifting the pallet interface 112 could be vertical lift, tilting, or a combination. The method could be one or more actuators, pneumatic, electric, manual, or a combination. In this embodiment, the two rear wheels 114 are tied together and the single front wheel 115 is separate. The second hydraulic piston 140 can be extended and retracted independently of the first hydraulic piston 138. This enables lifting and tilting fore and aft, but not tilting side to side or diagonally like the first embodiment.

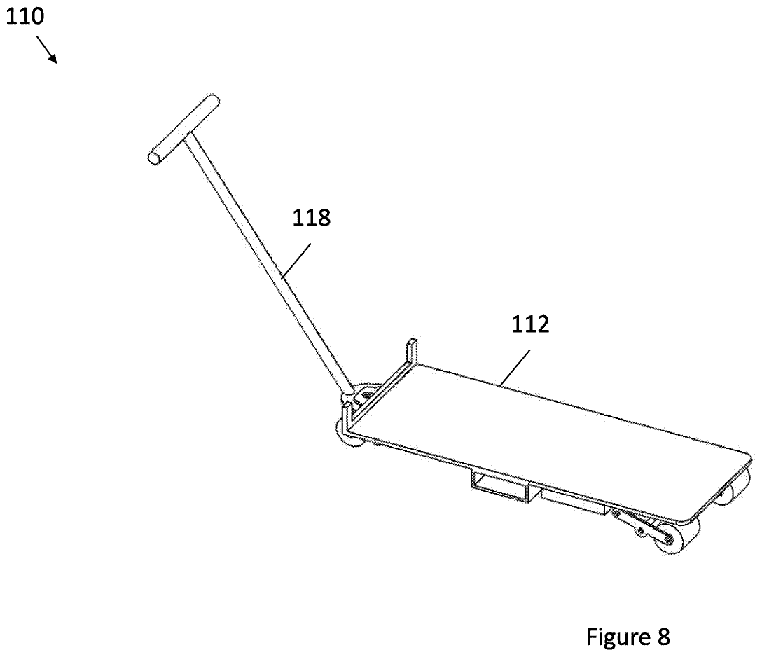

FIG. 8 is a perspective view of the pallet mover 110 of FIG. 6.

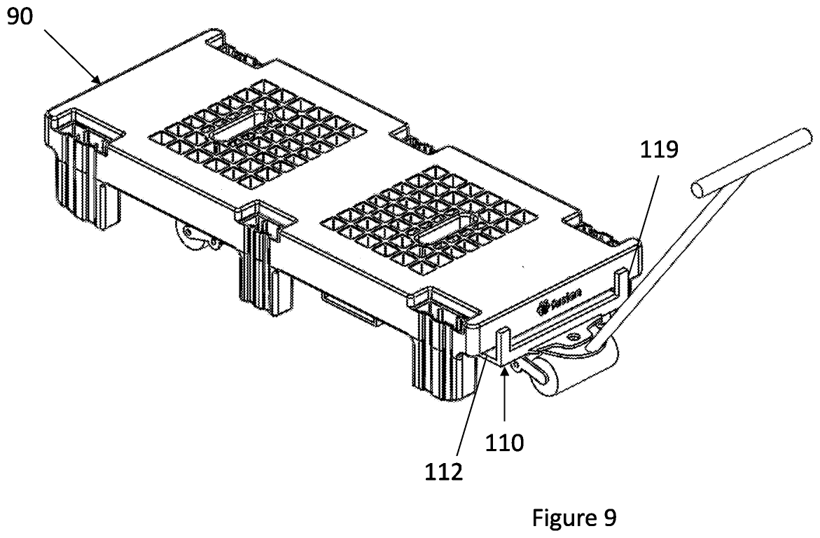

FIG. 9 shows the half pallet 90 on the pallet mover 110 positioned against the backrest 119 of the pallet interface 112.

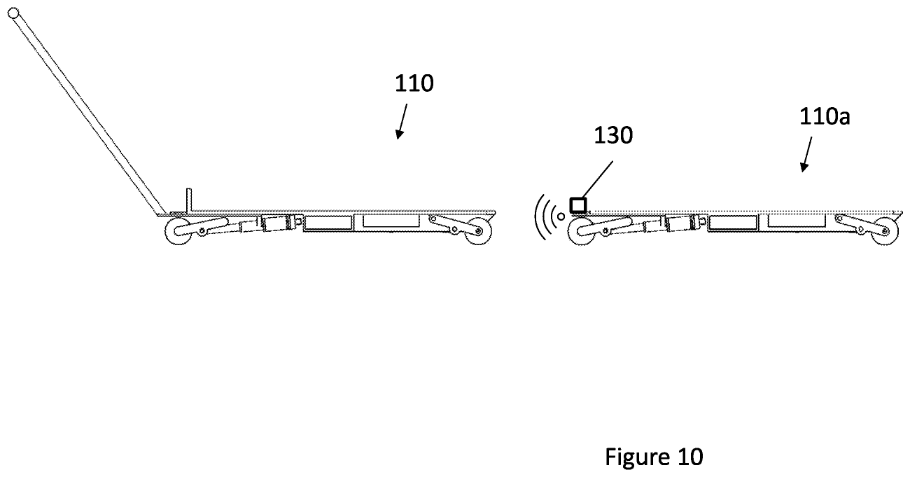

FIG. 10 shows the pallet mover 110 in use with a modified pallet mover 110a, which may be identical to the pallet mover 110 with the exception that the mast 118 has been removed. The modified pallet mover 110a is configured to follow the pallet mover 110 such that a user can steer the pallet mover 110 and the modified pallet mover 110a follows the pallet mover 110. In this manner a single user can bring two or more loaded pallet movers into a store at once. The modified pallet mover 110a does not include a mast 118, but includes sensors 130 that track the position of the pallet mover 110. The controller 128 uses information from the sensors 130 to follow the pallet mover 110.

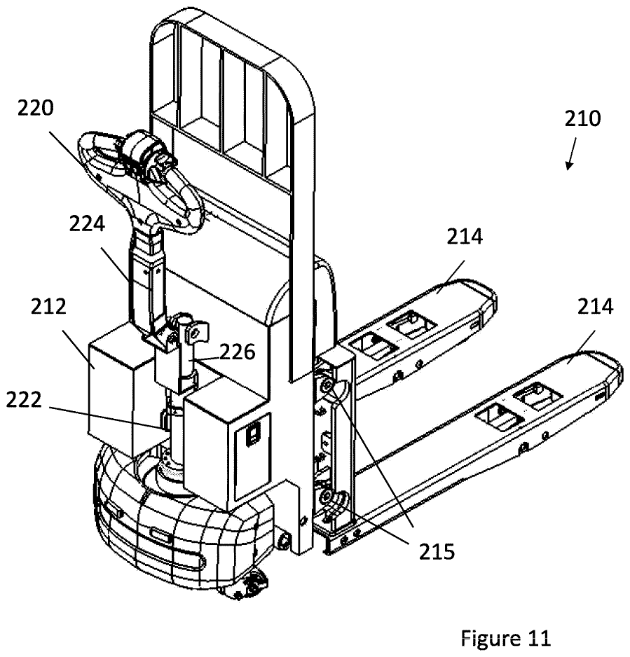

A pallet mover 210 according to another embodiment is shown in FIG. 11. The pallet mover 210 includes a lift module or base 212 containing the lift mechanisms and the tine spacing actuators 215. The base 212 is connected to a pair of fork tines 214. The base 212 can raise and lower the fork tines in a known manner, by leveraging the load wheels 216 supporting the tines 214 with a push rod, such as by hydraulics, pneumatics, electric motors, or via a manual actuator. The base 212 can also move the tines toward and away from one another with the tine spacing actuators 215, which could be hydraulics, pneumatics, electric motors driving a ball screw or a threaded rod, or via a manual actuator.

The pallet mover mechanism could be semi-electric, e.g. electric drive system and manual lifting (via pumping the tiller arm) or full-electric, e.g. electric drive system and electric lifting/lowering. In this example, the lift is semi- or full-electric, so battery power exists on the equipment to drive the actuators whether it be an electric hydraulic pump or electric motor. Other power sources could be provided, including manual.

The pallet mover 10 may provide a mechanism for facilitating the adjustment of the tine spacing without dragging the load wheels 216. Several such mechanisms are disclosed in U.S. Pat. No. 10,988,155 B2 , which is co-owned with this application, and which is hereby incorporated by reference in its entirety.

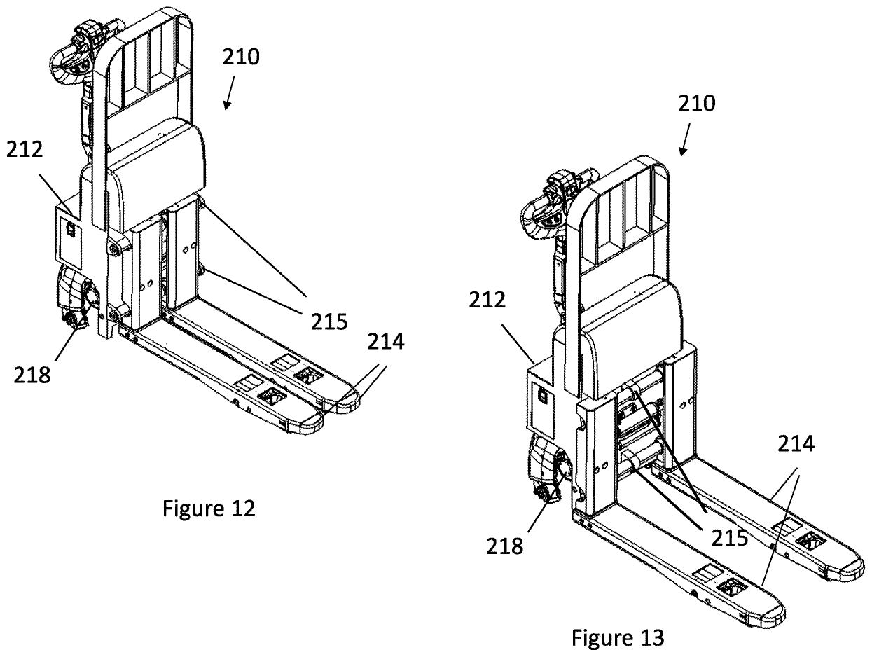

The base 212 is supported by a base wheel 218 (FIG. 12) having a tiller arm 220 extending upwardly therefrom. The tiller arm 220 includes a vertical portion 222 and an upper portion 224 pivotable about a horizontal axis relative to the vertical portion 222. In this example, rotation of the vertical portion 222 about a vertical axis by the upper portion 224 directly rotates the base wheel 218. A base actuator 226 connects the base 212 to the base wheel 218 and selectively raises and lowers the base 212 relative to the base wheel 218. The base actuator 226 may include a hydraulic cylinder activated by a hydraulic pump in the base 212. The base actuator 226 extends through the vertical portion 222. The vertical portion 222 can rotate relative to the base actuator 226 and the base actuator 226 can move up and down within the vertical portion 222.

In this embodiment, the vertical portion 222 of the tiller arm 220 is positioned closer to the tines 214 than in prior art designs. The base 212 is split into right and left halves to permit the vertical portion 222 to be positioned closer to the tines 214. This in turn moves the base wheel 218 to move closer to the tines 214, which increases the traction of the base wheel 218. The vertical portion 222 is between the two halves of the base 212. For example, the hydraulic pump may be located in one half.

FIG. 12 is a perspective view of the pallet mover 210 of FIG. 11 with the tines in a retracted position. FIG. 13 is a perspective view of the pallet mover 210 of FIG. 11 with the tines in an expanded position. As shown in FIGS. 12 and 13, the tines 214 are movable laterally toward and away from one another by the tine spacing actuators 215 as controlled by the user.

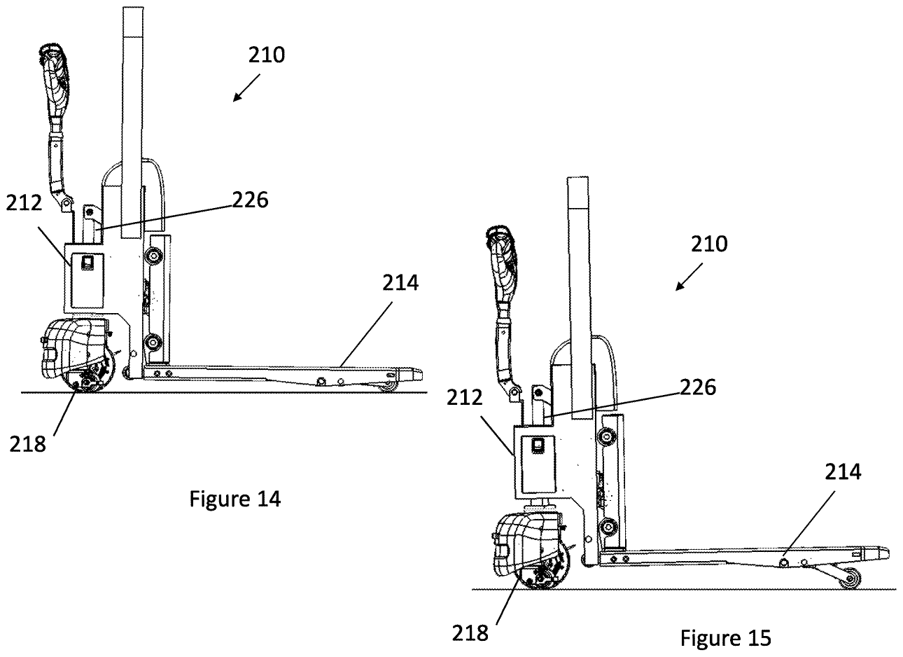

FIG. 14 is a side view of the pallet mover 210 with the tines 214 and base 212 in a low position. FIG. 15 is a side view of the pallet mover 210 with the tines 214 and base 212 in a raised position. As shown, the tines 214 are further away from the load wheels under the tines and the base 212 is further away from the base wheel 218.

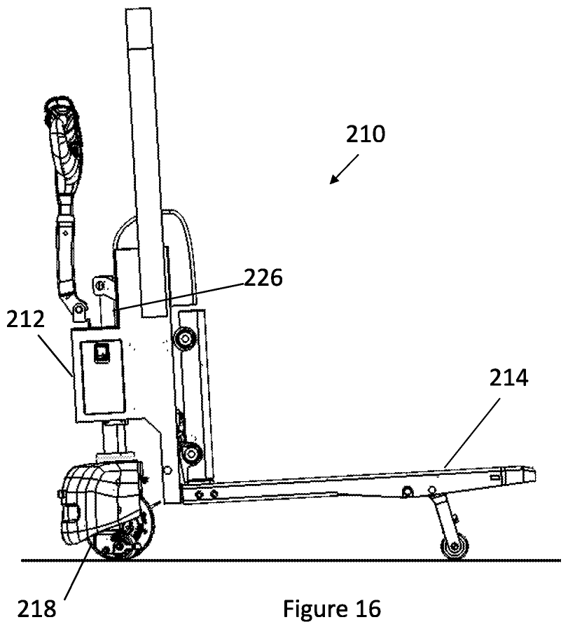

FIG. 16 is a side view of the pallet mover 210 in a fully raised position. As shown, the tines 214 are raised slightly more than the base 212 so that the tines 214 tilt back toward the backrest. This increases the stability of the goods on a pallet on the tines 214.

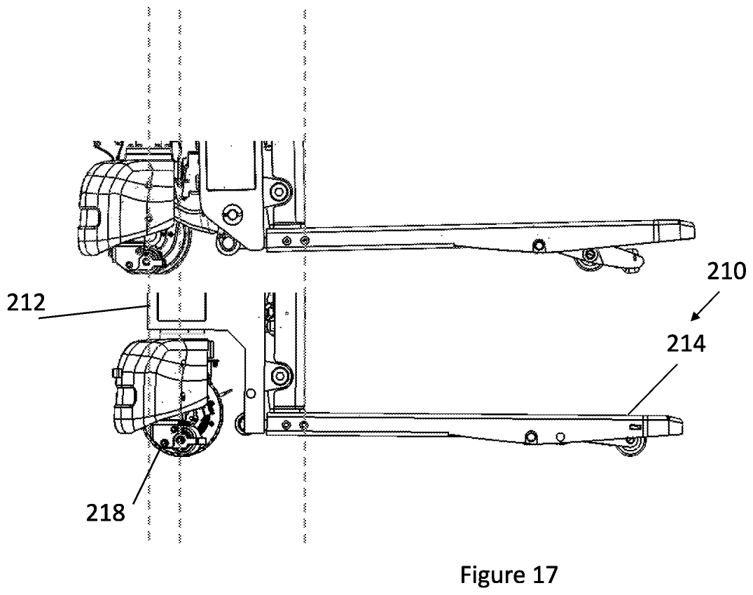

FIG. 17 is a side view of a lower portion of the pallet mover 210 of FIG. 11 adjacent the corresponding structure of a prior art pallet mover. As compared to the prior art, the base wheel 218 is closer to the tines 214, which transfers more weight onto the base wheel 218, thereby providing increased traction. The axle of the base wheel 218 is closer to the front surface of the backrest and closer to the tines 214, and the outer edge of the base wheel 218 is closer to the front surface of the backrest and the tines 214, as compared to the prior art structure.

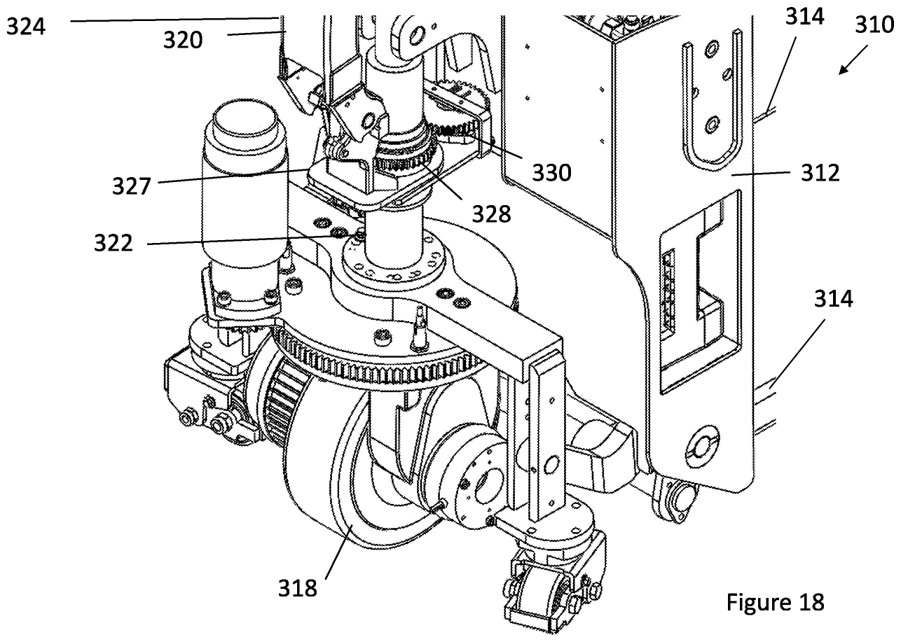

FIG. 18 is a perspective view of the base wheel 318 area of a pallet mover 310 according to another embodiment. The rest of the pallet mover 310 would be the same as the pallet mover 210 of FIG. 11, with or without the adjustable tine span, or could be in any configuration as the features of this pallet mover 310 are directed to the steering of the base wheel 318.

As shown in FIG. 18, a tiller arm 320 includes an upper portion 324 pivotably secured to a base plate 327 to which a first gear 328 is secured. The first gear 328 is rearward of where the tiller arm 320 attaches to the base plate 327. The base plate 327 is above the vertical portion 322 of the tiller arm 320. Rotation of the base plate 327 via the tiller arm 320 directly rotates the base wheel 318 and directly rotations the first gear 328 about the same vertical axis about which the base wheel 318 rotates for steering. The first gear 328 engages a steering angle sensor 330, such that the angle of the base wheel 318 relative to the base 312 and the tines 314 is always known to the controller. The steering angle sensor 330 could include a rotary potentiometer, rotary encoder, rotary variable differential transformer, Hall-effect angle sensor, or other suitable sensor.

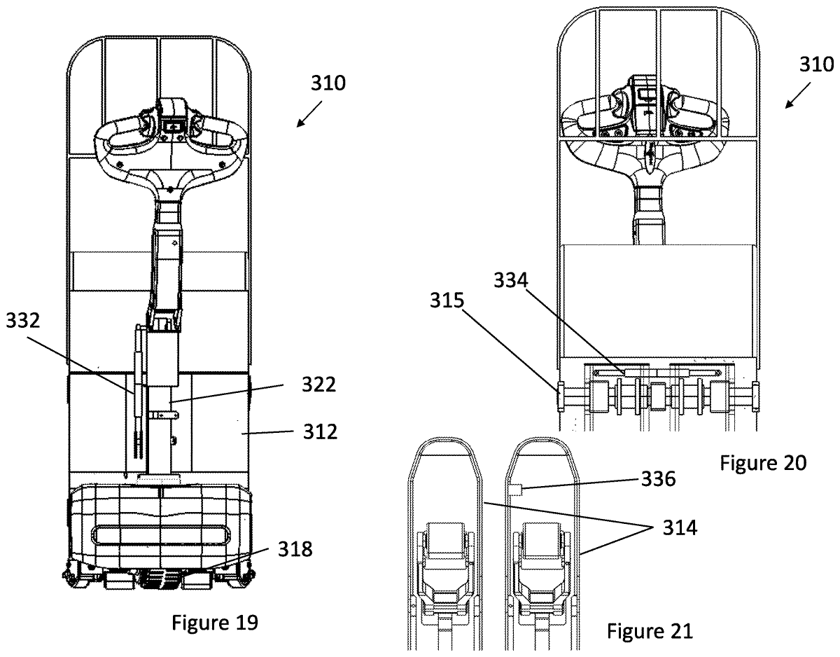

FIG. 19 is a front view of the pallet mover 310 of FIG. 18. A lift height position sensor 332 is connected to the base 312 and the base wheel 318 to measure the current lift height of the pallet mover 310 (e.g. the current height of the base 312 relative to the base wheel 318).

FIG. 20 is a rear view of the upper backrest area of the pallet mover 310 of FIG. 18. A fork width position sensor 334 is secured to two portions of the backrest that move with the tines as the tines are moved toward and away from one another.

The lift height position sensor 332 and fork width position sensor 334 can be linear variable differential transformers, linear potentiometers, magnetostrictive sensor, linear encoder or other suitable sensor. The lift height position sensor 332 provides continuous feedback on fork elevation, enabling the lift-height-dependent behaviors described in the tine tilt, knuckle length, and side-shift geometry entries —including programmable height limits, traction optimization, and wheelbase control.

FIG. 21 is a bottom view of the ends of the tines 314 of the pallet mover 310 of FIG. 18. A pallet position sensor 336 is mounted to the underside of one of the tines 314 proximate the end thereof. The pallet position sensor 336 may include an optical sensor, such as a camera with a very wide lens, directed downward at an angle and sending images to the controller. The controller is programmed for image recognition, such as via a local AI model. The controller uses the pallet position sensor 336 to determine the position of the tines 314 relative to the pallet. If the controller determines from the image that the wheels of the pallet mover 310 are on a portion of a pallet (e.g. a runner or bottom deckboard) then the controller so indicates to the user. Alternatively, the controller actually prevents the pallet mover 310 from “lifting” the pallet, which would other result in the runner or bottom deckboard breaking away from the rest of the pallet. As another alternative, a live image from the pallet position sensor 336 could be displayed to the user.

Additionally, the controller uses the pallet position sensor 336 to determine the longitudinal position of the tines 314 relative to the pallet. For example, for a particular pallet type it may be advantageous to position the pallet so that it is spaced away from the backrest. The controller monitors the images from the pallet position sensor 336 to determine the position of the pallet relative to the tines, such as by detecting the runners or bottom deckboards as the tines 314 are inserted below the deck of the pallet. This may be done in conjunction with monitoring the distance traveled by the pallet mover.

The columns of a nestable pallet will also be visible to the pallet position sensor 336, so the controller can be configured to determine the longitudinal position of the tines 314 relative to the columns of the nestable pallet. This can be used when a user is trying to lift one half pallet that is next to another half pallet. The controller and pallet position sensor 336 can determine the position of the tines 314 relative to one or both of the half pallets to ensure that the tines 314 are only below one of the half pallets and not partially under the other of the half pallets (which would otherwise cause the second half pallet to tip).

In this manner, the controller will always receive the current steering angle, the current lift height, the current fork width (if the variable tine span option is present), and the pallet position. The sensors 330, 332, 334, 336 are shown in this embodiment, but they could be used in any of the embodiments disclosed herein.

Additionally, the steering angle sensor 330, lift height position sensor 332, and fork width position sensor 334 each provide continuous, exact position data, rather than simply a binary indication that a fixed position has been reached. The controller operates a dynamic max speed algorithm that takes multiple real-time inputs simultaneously—steering angle, direction and current speed, load weight via hydraulic line pressure, lift height, and side-shift position—continuously calculating a safe operating envelope rather than relying on fixed thresholds.

Additionally, component drift and wear become detectable in real time—if a component that normally reaches a position in X milliseconds starts taking longer, that pattern is an early maintenance signal that binary sensors can never produce. Incomplete transitions are caught automatically, alerting when a component fails to fully reach its target. Exact hydraulic cylinder position enables pump modulation rather than full-pressure hard stops, reducing energy consumption per cycle. Combined with load weight from line pressure, lift position enables dynamic load moment calculations throughout the full range of motion—supporting overload protection and tilt compensation at every height by the controller, not just at fixed checkpoints.

Cycle time analytics, operator coaching, automatic homing, and zone-based behavioral enforcement are all enabled in the controller by the same underlying data stream.

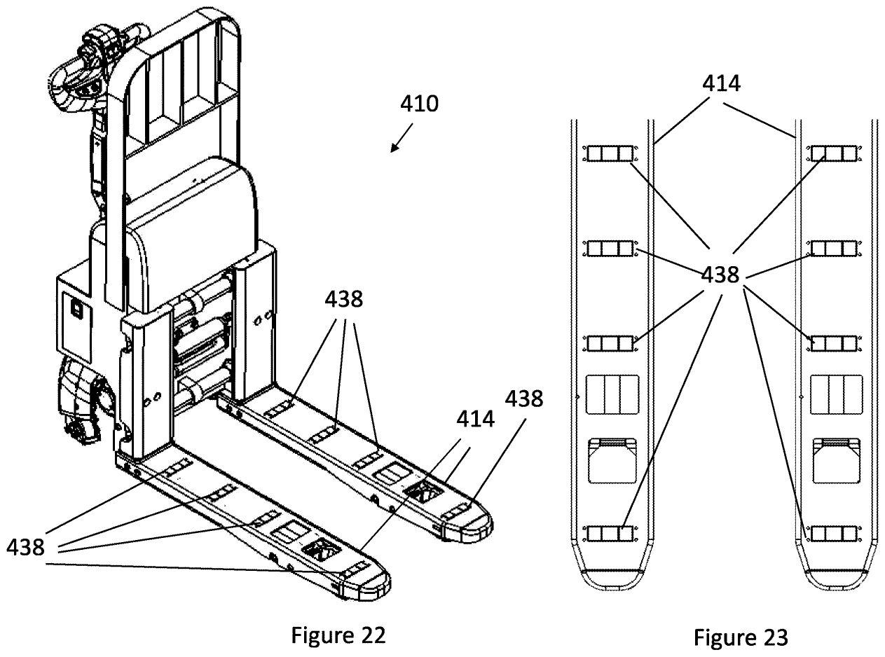

FIG. 22 is a perspective view of a pallet mover 410 according to another embodiment. The pallet mover 410 includes a pallet interface (such as tines 414, as shown). The rest of the pallet mover 410 can be the same as any other pallet mover 410 disclosed herein and the features disclosed herein with respect to the pallet interface of this embodiment can be used in any of the other pallet movers 410 disclosed herein.

The tines 414 each include a plurality of inserts 438 formed of elastomeric material, such as rubber. Each of the plurality of inserts 438 is secured to the upper support surface of the tines 414 or retained in an aperture or recess formed therein.

FIG. 23 is a top view of the tines 414 of the pallet mover 410 of FIG. 22. As shown, each tine 414 may include one insert 438 near an outermost end of the tine 414 and several more inserts 438 forward of the load wheel opening through the upper surface.

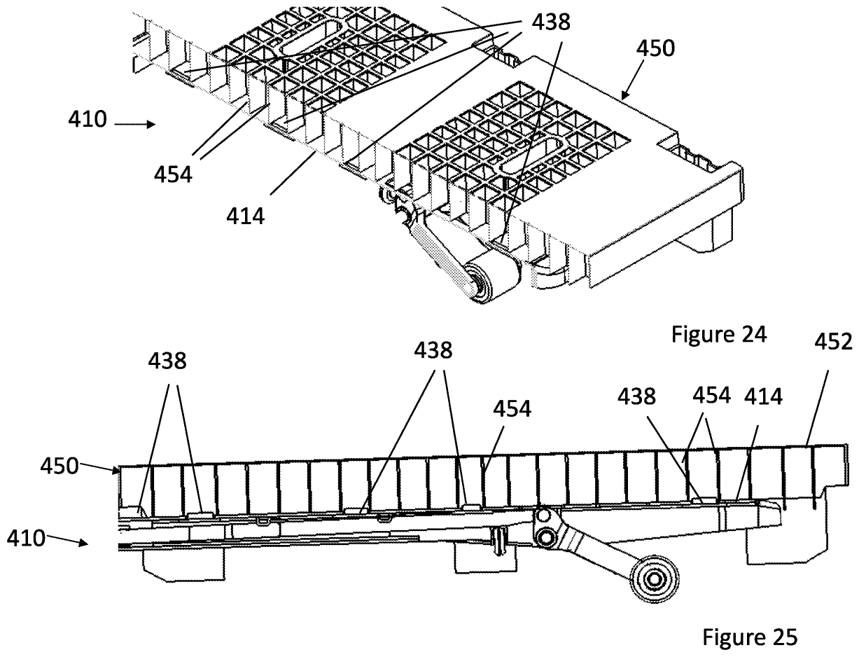

FIG. 24 is a perspective view of one of the tines 414 of the pallet mover 410 of FIG. 22, with a pallet 450 supported thereon, with both the pallet 450 and the tine 414 partially broken away. In this example the pallet 450 is a half pallet. FIG. 25 is a side view of the tine 414 and pallet 450 of FIG. 24. Referring to FIGS. 24 and 25, the plurality of inserts 438 are positioned on the tines 414 such that they will be positioned between ribs 454 of the deck 452 of the pallet 450. Because the plurality of inserts 438 protrude upward relative to the upper support surface of the tine 414, they will assist in retaining the pallet 450 in place on the tine 414. The other tine 414 would work identically.

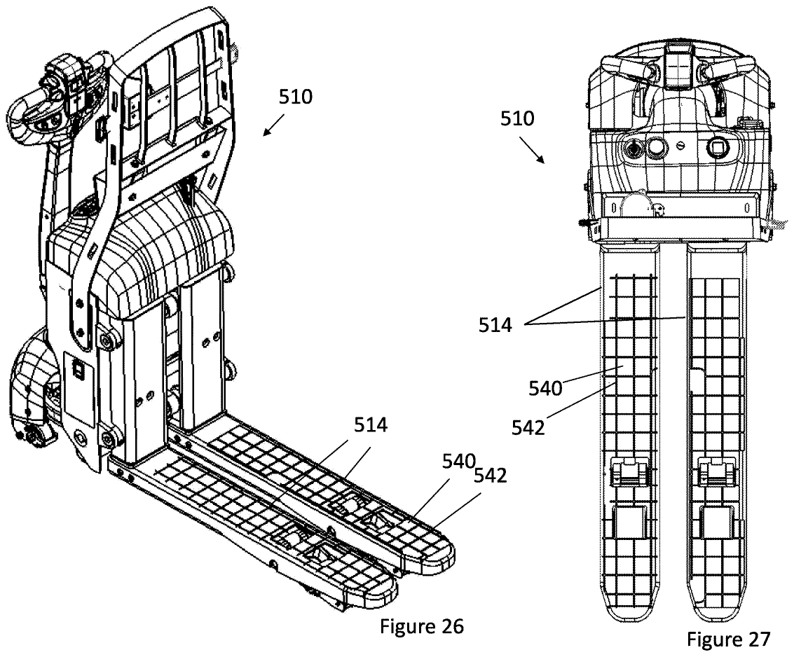

FIG. 26 is a perspective view of a pallet mover 510 according to another embodiment. Again the pallet mover 510 includes a pallet interface which in this example is tines 514. The pallet interface includes a pallet interlock feature that could be used in any embodiment disclosed herein. In the upper support surface of each tine 514 is formed a plurality of raised projections 540 separated by a grid of grooves 542. FIG. 27 is a top view of the pallet mover 510 of FIG. 26.

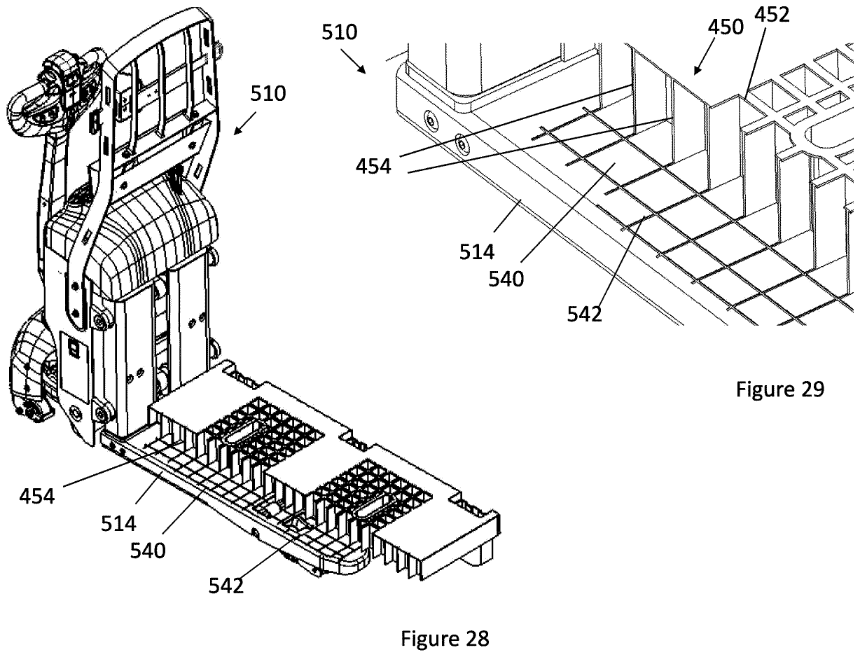

FIG. 28 is a perspective view of the pallet mover 510 with a pallet supported on the tines 514, the pallet being partially broken away. FIG. 29 is an enlarged view of a portion of FIG. 28. The ribs 454 of the deck 452 of the pallet 450 are received in the grooves 542 of the pallet interface (e.g. the tines 514). The plurality of raised projections 540 then protrude between the ribs 454, which retains the pallet 450 on the tines 514. Other shape projections could also be used.

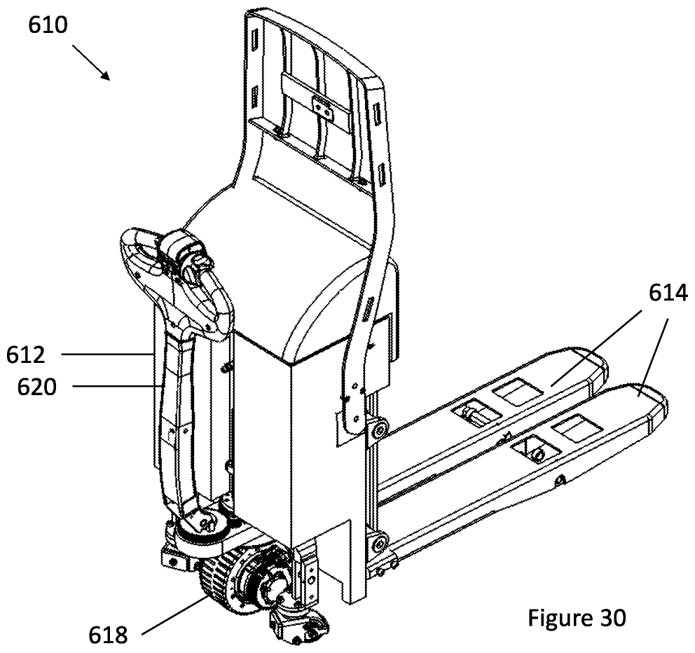

FIG. 30 is a perspective view of a pallet mover 610 according to another embodiment. Generally, as before, the pallet mover 610 includes a pallet interface, which in this example is a pair of tines 614. In this example the tines 614 can be moved laterally relative to one another. A base wheel 618 supports a base 612. A tiller arm 620 is provided for steering the pallet mover 610. As shown, in this embodiment, the base wheel 618 is positioned below the base 612 and close to the backrest and closer to the tines 614.

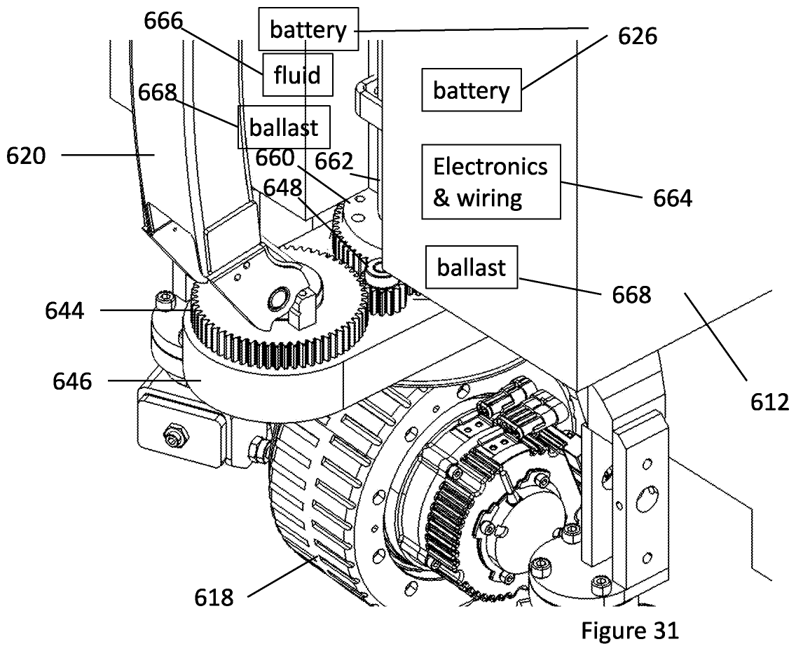

FIG. 31 is an enlarged view of the base wheel 618 area of the pallet mover 610 of FIG. 30. The tiller arm 620 is pivotable about a horizontal axis to a bracket fixed to a first gear 644. The first gear 644 is rotatable about a vertical axis and is mounted to a base plate 646 fixed to the base 612. The first gear 644 engages a small second gear 648 which in turn engages a steering gear 660 which is directly secured to the vertical shaft 662 connected to the base wheel 618. Rotation of the first gear 644 caused by the user via the tiller arm 620 causes first gear 644 to rotate. The small second gear 648 transmits this rotation to the steering gear 660, which causes the base wheel 618 to turn.

The gears permit the tiller arm 620 to be outside the base 612 and position the base wheel 618 directly below the base 612. The vertical axis about which the base wheel 618 turns is between the two halves of the base wheel 618. The vertical axis about which the base wheel 618 turns is no longer the same axis about which the tiller arm 620 pivots. The tiller arm 620 pivots about an axis spaced away from the vertical axis about which the base wheel 618 turns. The halves contain electronics and wiring 664, batteries 626, a hydraulic fluid reservoir 666, and/or ballast weight 668 (all of these could be in either or both halves).

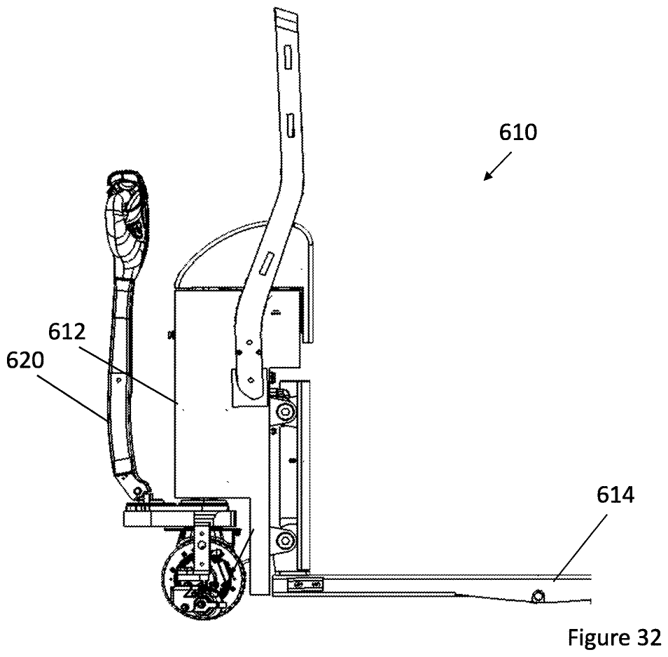

FIG. 32 is a side view of the pallet mover 610. As shown, the base 612 is directly over the base wheel 618. This places more weight directly over the base wheel 618 increasing traction.

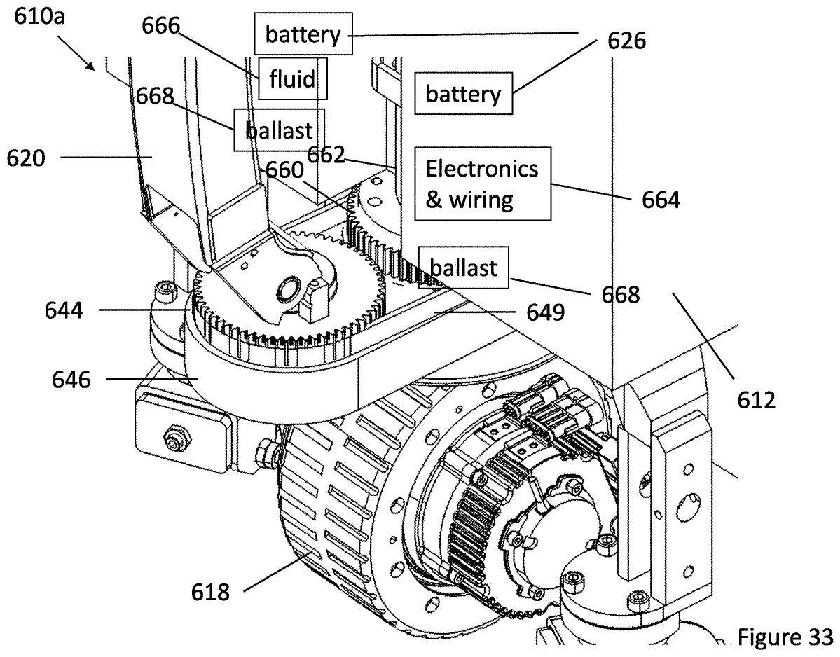

FIG. 33 shows the base wheel area of FIG. 30 of an alternate pallet mover 610a with an alternate connection to the steering gear 660. The rest of the pallet mover 610a is identical to the pallet mover 610 of FIGS. 30-32. In this embodiment a chain or belt 649 connects the first gear 644 to the steering gear 660. Again, rotation of the first gear 644 with the tiller arm 620 will cause rotation of the steering gear 660 and the base wheel 618.

The tiller arm (or other steering device) could also be coupled to the steering gear or the vertical shaft or the base wheel via flexible shafts, cogs/chains. Alternatively, the tiller arm position could drive a tiller arm sensor input, which in turn sends a signal to a motor to turn the vertical shaft and the base wheel. This would permit the base wheel to be moved further under the base and to further separate the tiller arm (or other steering device) and the base wheel. If a motor is used to turn the base wheel, then the steering device could be any user input, such as a joystick, steering wheel, tiller arm, etc. Again, the point is to move the steering device away from the axis about which the base wheel turns. If a standard size tiller arm is used, that tiller arm can pivot about an axis (which may be vertical or mostly vertical) that is spaced away from the axis about which the base wheel turns.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. In particular, it is specifically noted that features disclosed in different embodiments could be used together in the same pallet mover.

What is claimed is:

1. A pallet mover comprising:
a pallet interface configured to support a load;
a plurality of wheels supporting the pallet interface above a floor; and
a plurality of wheel interfaces, each wheel interface connecting an associated one of the plurality of wheels to the pallet interface, wherein each wheel interface is configured to selectively increase and decrease a distance between the associated wheel and the pallet interface and to pivot the associated wheel about a vertical axis independently of others of the plurality of wheel interfaces.

2. The pallet mover of claim 1 wherein each of the plurality of wheels is powered.

3. The pallet mover of claim 2 wherein each of the plurality of wheels includes a hub motor.

4. The pallet mover of claim 1 further comprising a controller configured to independently control each wheel interface so as to selectively raise, lower, tilt, and steer the pallet interface.

5. The pallet mover of claim 4 further comprising a battery mounted to an underside of the pallet interface.

6. The pallet mover of claim 1 wherein all of the plurality of wheels are positioned directly below the pallet interface.

7. The pallet mover of claim 1 wherein the wheel interfaces are configured to tilt the pallet interface about both a longitudinal axis and a lateral axis.

8. The pallet mover of claim 1 wherein the pallet interface is one of a blade or a set of fork tines.

9. The pallet mover of claim 1 further comprising a mast extending upwardly from the pallet interface, the mast including handlebars at an upper end thereof and a user interface mounted below the handlebars.

10. The pallet mover of claim 1 further including a controller including at least one of a traction control feature, a stability control feature that limits speed based on lift height or steering angle, or a differential steering feature.

11. A pallet mover comprising:
a base split into right and left halves;
a pair of fork tines extending forward from the base;
a base wheel supporting the base; and
a tiller arm having a vertical portion positioned between the right and left halves of the base, the tiller arm operatively connected to the base wheel such that rotation of the tiller arm rotates the base wheel about a vertical axis, wherein the positioning of the vertical portion between the halves places the base wheel closer to the fork tines than in a conventional pallet jack configuration.

12. The pallet mover of claim 11 further comprising a pair of load wheels, one supporting each fork tine, and wherein the base further includes a lift actuator configured to selectively raise and lower the base and the fork tines relative to the base wheel and the load wheels.

13. The pallet mover of claim 11 further comprising tine spacing actuators mounted in the base and configured to selectively move the fork tines laterally toward and away from one another.

14. The pallet mover of claim 11 further comprising a steering angle sensor configured to detect a rotational position of the base wheel relative to the base.

15. The pallet mover of claim 11 further comprising at least one of a lift height position sensor and a fork width position sensor.

16. The pallet mover of claim 11 further comprising a pallet position sensor mounted to an underside of at least one of the fork tines proximate a forward end thereof.

17. The pallet mover of claim 11 wherein the fork tines each include an upper support surface having a plurality of elastomeric inserts protruding upwardly therefrom, the inserts positioned so as to be received between ribs of a pallet deck when the pallet is supported on the fork tines.

18. The pallet mover of claim 11 wherein each fork tine includes an upper support surface having a plurality of raised projections separated by a grid of grooves, the raised projections and grooves configured to interlock with ribs of a pallet deck supported on the fork tines.

19. The pallet mover of claim 11 further comprising a gear train operatively connecting the tiller arm to the base wheel such that the tiller arm remains outside the base while the base wheel is positioned directly beneath the base.

20. A pallet mover comprising:
a base;
a pair of tines extending forward from the base, the tines configured to support a pallet;
a base wheel supporting the base, wherein the base wheel is positioned directly below the base and is pivotable about a first axis to steer the pallet mover; and
a steering device configured to cause the base wheel to pivot about the first axis, wherein the steering device is spaced away from the first axis.

21. The pallet mover of claim 20 further including:
a first gear rotatable by the steering device; and
a steering gear driven by the first gear and coupled to the base wheel, such that rotation of the steering device causes the base wheel to pivot about the first axis.

22. The pallet mover of claim 21 further including a second gear engaged between the first gear and the steering gear.

23. The pallet mover of claim 21 further including a belt or chain coupling the first gear to the steering gear.

24. The pallet mover of claim 20 wherein the base is split into right and left halves, and wherein the first axis about which the base wheel pivots is located between the two halves of the base.

25. The pallet mover of claim 24 wherein the right and left halves of the base each contain at least one of: electronics and wiring, one or more batteries, a hydraulic fluid reservoir, or ballast weight.

26. A pallet mover comprising:
a base;
a base wheel supporting the base;
a pair of tines extending forward from the base;
load wheels supporting the pair of tines; and
a pallet position sensor mounted to one of the pair of tines and configured to detect a pallet position relative to the one of the tines.

27. The pallet mover of claim 26 wherein the pallet position sensor includes a camera.

28. The pallet mover of claim 27 wherein the camera is directed downward of the one of the pair of tines.
